(19) United States
(12) Patent Application Publication
(10) Pub. No.: US 2012/0191783 A1
(43) Pub. Date: Jul. 26, 2012

(54) METHOD, DEVICE AND SYSTEM FOR CONTENT SHARING AND PROPAGATION

(75) Inventor: Zanfeng Yang, Nanjing (CN)

(73) Assignee: Huawei Technologies Co., Ltd., Shenzhen (CN)

(21) Appl. No.: 13/436,209

(22) Filed: Mar. 30, 2012

Related U.S. Application Data
(63) Continuation of application No. PCT/CN2010/077994, filed on Oct. 22, 2010.

(30) Foreign Application Priority Data
Oct. 22, 2009 (CN) 200910236458.6

(51) Int. Cl. G06F 15/16

(52) U.S. Cl. 709/204

(57) ABSTRACT

A method, a device and a system for content sharing and propagation are provided. A gateway receives a service access request sent by a terminal, obtains content corresponding to the service access request from a network server, determines content required to be shared in the content corresponding to the service access request according to a sharing rule, feeds back a sharing prompt to the terminal, receives a sharing request sent by the terminal, and sends the content required to be shared according to the sharing request. A network side determines the content to be shared according to the sharing rule, and feeds back a sharing prompt, for example, provides a sharing link, so that the user can to share the content with friends conveniently and instantly when the user browses Internet content.

### CROSS-REFERENCE TO RELATED APPLICATIONS

This application is a continuation of International Application No. PCT/CN2010/077994, filed on Oct. 22, 2010, which claims priority to Chinese Patent Application No. 200910236458.6, filed on Oct. 22, 2009, both of which are hereby incorporated by reference in their entireties.

### FIELD

The present disclosure relates to the field of communications technologies, and in particular, to a method, a device and a system for content sharing and propagation.

### BACKGROUND

Web 2.0 is also referred to as Internet 2.0, and represents a new era of network application, in which the network becomes a new platform, content is generated due to participation of each user, and personal content generated due to the participation forms a world of Web 2.0 through sharing among people.

Technologies of Web 2.0 mainly include: a blog (BLOG), an RSS (Really Simple Syndication, aggregation content, a simple manner of sharing content on line), an encyclopedia (Wiki), a social network (SNS), P2P and instant messaging (IM).

When a user accesses Internet content through a browser, finds content (for example, articles, pictures, and videos) the user is interested in, and wants to share the content with friends, a method for implementing content sharing in a first solution in the prior art is as follows: the user saves the content locally, and then notifies the friends of the saved specific URL link or specific content by means of such as a short message, a multimedia message, an Email, or printing.

The sharing method in the first solution in the prior art at least has the following disadvantages:

1. The user needs to actively use other methods (for example, by means such as a short message, a multimedia message, an Email, or printing), and many operations are required.

2. Most of mobile terminal browsers used by a user do not support paste and copy functions, resulting in inconvenience in operation.

3. The content required to be shared, such as a picture or a long paragraph of text, cannot be shared due to limitations of message sending technology of a mobile terminal and text quantity; and if the content required to be shared such as an audio and a video is shared through a multimedia message, the multimedia message needs to be made at a terminal, it is difficult to share the content or the operation is complicated due to the limitation of the size limit of the multimedia message.

A method for sharing the content in a second solution in the prior art is as follows: an Internet content provider adds a “share” link in the web page, so that the user can share the content with friends through an Email.

The sharing manner in the second solution in the prior art at least has the following disadvantages.

1. The Internet content provider needs to add a “share” link one by one for the content and provides a sharing function, which increases difficulty and a technical threshold of the sharing, and content provided for sharing is limited.

2. The sharing can only be implemented through an Email, and the sharing manner is single.

To sum up, the current solution for content sharing needs to locally save the content to be shared, and the shared content is limited by the sending manner; while it is very difficult to implement the method of adding the “share” link one by one by the Internet content provider, and the sharing manner is single.

### SUMMARY

Embodiments of the present disclosure provide a method, a device and a system for content sharing and propagation.

Embodiments of the present disclosure are implemented through the following solutions.

An embodiment of the present disclosure provides a method for content sharing and propagation, where the method includes: receiving, by a gateway, a service access request sent by a terminal, and obtaining content corresponding to the service access request from a network server; determining content required to be shared in the content corresponding to the service access request according to a sharing rule and feeding back a sharing prompt to the terminal; receiving a sharing request sent by the terminal; and sending the content required to be shared according to the sharing request.

An embodiment of the present disclosure provides a device for implementing content sharing and propagation, where the device includes: a first receiving unit, configured to receive a service access request sent by a terminal, and obtain content corresponding to the service access request from a network server; a shared content determination and feedback unit, configured to determine content required to be shared in the content corresponding to the service access request according to a sharing rule and feed back a sharing prompt to the terminal; a second receiving unit, configured to receive a sharing request sent by the terminal; and a sending unit, configured to send the content required to be shared according to the sharing request.

An embodiment of the present disclosure provides a method for content sharing and propagation, where the system includes: a network server and a gateway, where the network server is configured to provide a web page of content corresponding to a service access request to the gateway after receiving a service access request forwarded by the gateway; and the gateway is configured to receive the service access request sent by a terminal, obtain content corresponding to the service access request from the network server, determine content required to be shared in the content corresponding to the service access request according to a sharing rule, feed back a sharing prompt to the terminal, and send the content required to be shared according to a sharing request after receiving the sharing request sent by the terminal.

It can be seen from the above solutions provided by the embodiments of the present disclosure that, through the embodiments of the present disclosure, the user is not required to locally download the content required to be shared, and the content provider is also not required to modify the content. A network side determines, according to the sharing rule, the content to be shared and returns a sharing prompt to the terminal, for example, providing a sharing link, so that the user can share the content with friends conveniently and instantly when the user browses Internet content.

### BRIEF DESCRIPTION OF THE DRAWINGS

To describe the solutions according to the embodiments of the present disclosure or in the prior art more clearly, the accompanying drawings for describing the embodiments or the prior art are introduced briefly in the following. Apparently, the accompanying drawings in the following description are only some embodiments of the present disclosure, and persons skilled in the art can derive other drawings from the accompanying drawings without creative efforts.

FIG. 1 is a schematic structural diagram of a system for content sharing and propagation according to an embodiment of the present disclosure;

FIG. 2 is a schematic structural diagram of a gateway device according to an embodiment of the present disclosure;

FIG. 3 is a flow chart of a method for content sharing and propagation according to an embodiment of the present disclosure;

FIG. 4 is a flow chart of Example 1 of a method for content sharing and propagation according to the present disclosure;

FIG. 5 is a flow chart of Example 2 of a method for content sharing and propagation according to the present disclosure; and

FIG. 6 is a flow chart of Example 3 of a method for content sharing and propagation according to the present disclosure.

### DETAILED DESCRIPTION OF THE EMBODIMENTS

The solutions of the present disclosure are described in the following with reference to the accompanying drawings. It is obvious that the embodiments to be described are only a part rather than all of the embodiments of the present disclosure. All other embodiments obtained by persons skilled in the art based on the embodiments of the present disclosure without creative efforts shall fall within the protection scope of the present disclosure.

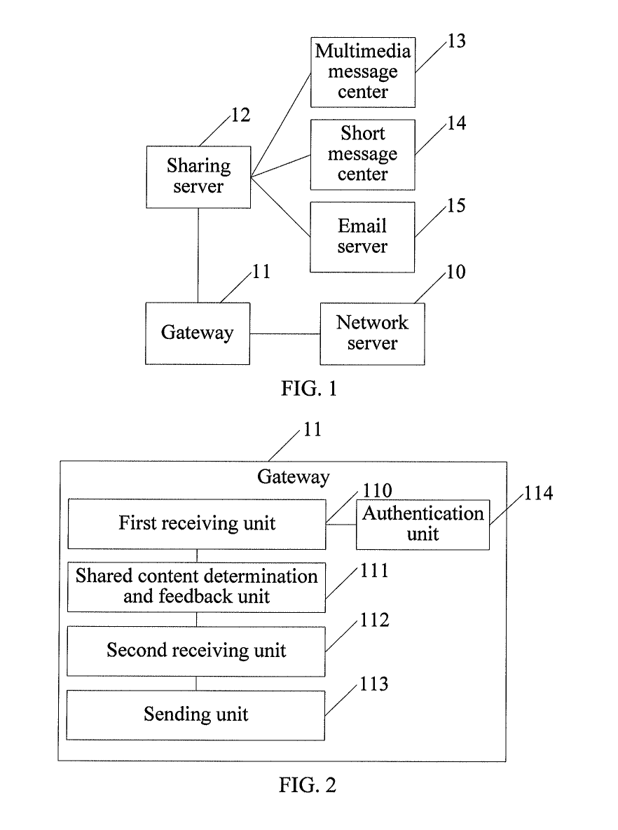

An embodiment of the present disclosure provides a system for content sharing and propagation. As shown in FIG. 1, the system includes: a network server 10 and a gateway 11.

The network server 10 is configured to provide content corresponding to a service access request to the gateway 11 after receiving the service access request sent by the gateway 11, where the content provided by the network server 10 may be provided to the gateway 11 in the form of a webpage. The content includes, but is not limited to, an article, a picture, a video and an audio.

The gateway 11 is configured to receive the service access request sent by a terminal, obtain content corresponding to the service access request from the network server 10, determine, according to a sharing rule, content required to be shared (which may also be construed as content that may be shared or suitable to be shared) in the content corresponding to the service access request, feed back a sharing prompt to the terminal to determine whether to share the content required to be shared with other users, and send the content required to be shared after receiving a sharing request sent by the terminal; for example, a manner of feeding back the sharing prompt to the terminal by the gateway 11 may include: adding a sharing link in a page including the content required to be shared and sending the page added with the sharing link to the terminal.

The gateway 11 may be further configured to authenticate the terminal.

The gateway 11 may be further configured to receive the service access request sent by the terminal, send the service access request to the network server 10, and request the corresponding content from the network server 10.

The sharing rule may be preset and stored by the gateway. The sharing rule includes, but is not limited to the following: conditions such as a terminal identity, a terminal type and a website address are combined to form rules, and it is determined that the content that complies with the rules required to be shared; or, the text content of a web page is used as the sharing rule, including, but not limited to, a word count of a text paragraph in a web page exceeding a certain amount; or, a label of a subject included in a markup language (HTML, XHTML, WML), such as h1-h2 in HTML, and it is determined that the content that complies with this rule required to be shared; or a sharing rule for a picture in a web page may be configured, including, but not limited to, that any one or any combination of a width limit, a height limit, a size limit, and a picture type of the picture, accordingly it is determined that the content that complies with the rules required to be shared.

It can be understood that, the sharing rules mentioned above are merely several examples listed by the inventors, and a sharing rule may be set according to the requirements in actual applications or multiple rules can be combined for use.

Optionally, the system may further include a sharing server 12.

The method for sending the content required to be shared by the gateway 11 may be as follows: the gateway 11 sends a notification to the sharing server 12, where the notification includes: content required to be shared, an identity of a terminal requesting sharing, and an identity of a sharing receiver (that is, an identity of a destination receiver of the content required to be shared).

The sharing server 12 is configured to receive the notification of the gateway 11 and send the content required to be shared to the sharing receiver. As shown in FIG. 1, the sharing server 12 may be connected to a multimedia message center 13, a short message center 14 or an Email (Email) server 15, and send the content required to be sent to the sharing receiver in a manner of a multimedia message, a short message or an Email. The embodiment of the present disclosure does not limit the manner in which the sharing server 12 sends the content required to be shared. In addition to the multimedia message, the short message or the Email listed above, other sending manners developed by persons skilled in the art should fall within the protection scope of the present disclosure. In the embodiment of the present disclosure, the content required to be shared is sent by using the sharing server 12, so that the problem of the sharing manner is single and sending manner of the content to be shared is limited is solved.

The embodiment of the present disclosure does not limit protocols applied between the devices, for example, the Hypertext Transport Protocol (HTTP, Hypertext Transport Protocol) may be applied between the terminal and the gateway; the HTTP protocol may be applied between the gateway and the network server; the HTTP protocol may also be applied between the gateway and the sharing server; an MM7 protocol may be applied between the sharing server and the multimedia message center; a Short Message Peer-To-Peer Protocol (SMPP, Short Message Peer-To-Peer Protocol) may be applied between the sharing server and the short message center; and an SMTP protocol may be applied between the sharing server and an Email server.

To implement the functions of the gateway, a structure of an embodiment of the gateway 11 is shown in FIG. 2, where the structure includes:
a first receiving unit 110, configured to receive a service access request sent by a terminal, and obtain content corresponding to the service access request from a network server;
a shared content determination and feedback unit 111, configured to determine content required to be shared in the content corresponding to the service access request according to the sharing rule and feed back the content to the terminal, where the shared content determination and feedback unit 111 may further include the following two sub-units: a determination sub-unit 1110 (not shown), configured to determine content required to be shared in the content corresponding to the service access request according to the sharing rule; and a feedback sub-unit 1111 (not shown), configured to add a sharing link in a web page including the content required to be shared, and send the page added with the sharing link to the terminal, and it can be understood that, the structure of the shared content determination and feedback unit 111 is not limited thereto; and
a second receiving unit 112, configured to receive a sharing request sent by the terminal; and
a sending unit 113, configured to send the content required to be shared.

The gateway device 11 may further include:
an authentication unit 114, configured to authenticate the terminal;

The gateway includes, but is not limited to, a Wireless Application Protocol (WAP, Wireless Application Protocol) gateway, a WEB gateway, an Internet Proxy, and a service control gateway.

Through the embodiment of the present disclosure, the user is not required to locally download the content required to be shared, and the content provider is not required to modify the content. A network side determines the content to be shared (content that may be shared or content that is required to be shared) according to the sharing rule and returns a sharing prompt to the terminal for selection and acknowledgement, for example, providing a sharing link, so that the user can share the content with friends conveniently and instantly when the user browses Internet content. Moreover, the content sharing and transmission are implemented based on the gateway, thereby ensuring the security of a content sharing process.

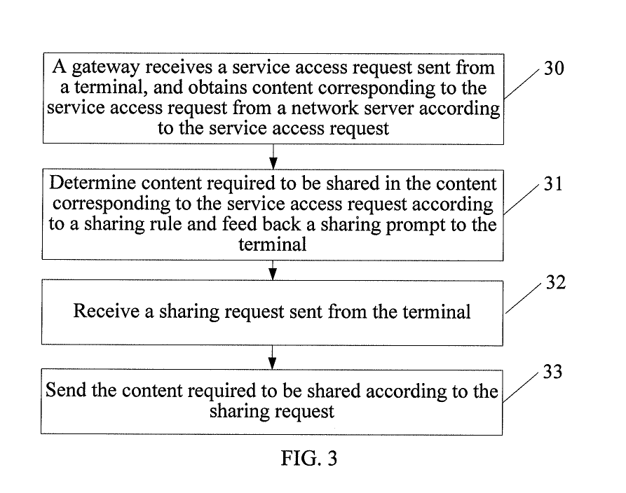

An embodiment of the present disclosure also provides a method for content sharing and propagation. As shown in FIG. 3, the method includes the following steps:

Step 30: A gateway receives a service access request sent by a terminal, and obtains content corresponding to the service access request from a network server.

Generally, the gateway may perform an authentication operation on an accessed terminal, that is, the gateway can obtain information about the terminal, and can determine whether the accessed terminal is legal according to the information of the terminal. Therefore, the method for content sharing and propagation in the embodiment of the present disclosure can ensure the security of the terminal requesting sharing.

The process that the gateway obtains the corresponding content from the network server that provides service content according to the service access request includes: after receiving the service access request sent by the terminal, the gateway sends the service access request to the network server, and receives content that corresponds to the service access request and is returned by the network server, where the network server generally provides the content corresponding to the service access request in the form of a web page.

Step 31: Determine content required to be shared in the content corresponding to the service access request according to a sharing rule and feed back a sharing prompt to the terminal.

After receiving the content that corresponds to the service access request and is provided by the network server, the gateway determines the content required to be shared according to the sharing rule. That is, the gateway judges whether the content provided by the network server meets sharing requirements, and determines the content required to be shared if the content meets the sharing requirements. The sharing rule includes, but is not limited to, the following: conditions such as a terminal identity, a terminal type and a website address are combined to form the rules, and it is determined that the content that complies with the rules required to be shared; or, the text content of a web page is used as the sharing rule, including, but not limited to, a word count of a text paragraph in a web page exceeding a certain amount; or, a label of a subject included in a markup language (HTML, XHTML, WML), such as h1-h2 in HTML, and it is determined that the content that complies with this rule required to be shared; or, a sharing rule for a picture in a web page may be configured, including, but not limited to, that any one or any combination of a width limit, a height limit, a size limit, and a picture type of the picture, and it is determined that the content that complies with the rules required to be shared.

If it is determined that the content is not required to be shared, the web page is directly provided to the terminal.

Step 32: Receive a sharing request sent by the terminal.

The sharing request may include an identity of a sharing receiver.

If the user determines that the content is required to be shared with friends, the terminal may send the sharing request through a sharing link, in which the sharing request includes an identity of a sharing receiver, that is, friends with whom the content is shared, and an identity of the sharing receiver may include, but is not limited to, an Email address and a phone number of the sharing receiver.

Step 33: Send the content required to be shared according to the sharing request.

For example, after receiving the sharing request, the gateway sends the content required to be shared that is determined in step 31, the identity of the terminal requesting sharing, and the identity of the sharing receiver to the sharing server, and then the sharing server sends the content required to be shared to the sharing receiver. The manner of the sharing server sending the content required to be shared to the sharing receiver may include, but is not limited to: sending a multimedia message, a short message or an Email through a multimedia message center, a short message center or an Email server.

Through the embodiment of the present disclosure, the user is not required to locally download the content required to be shared, and the content provider is also not required to modify the content. A network side determines the content to be shared according to the sharing rule, and feeds back a sharing prompt to the terminal, for example, providing a sharing link, so that the user can share the content with friends conveniently and instantly when the user browses Internet content. Moreover, the content sharing and propagation are implemented based on the gateway, thereby ensuring the security of a content sharing process.

For the convenience of understanding the present disclosure, the method described according to the foregoing embodiment is illustrated in detail in the following with specific examples.

### Example 1

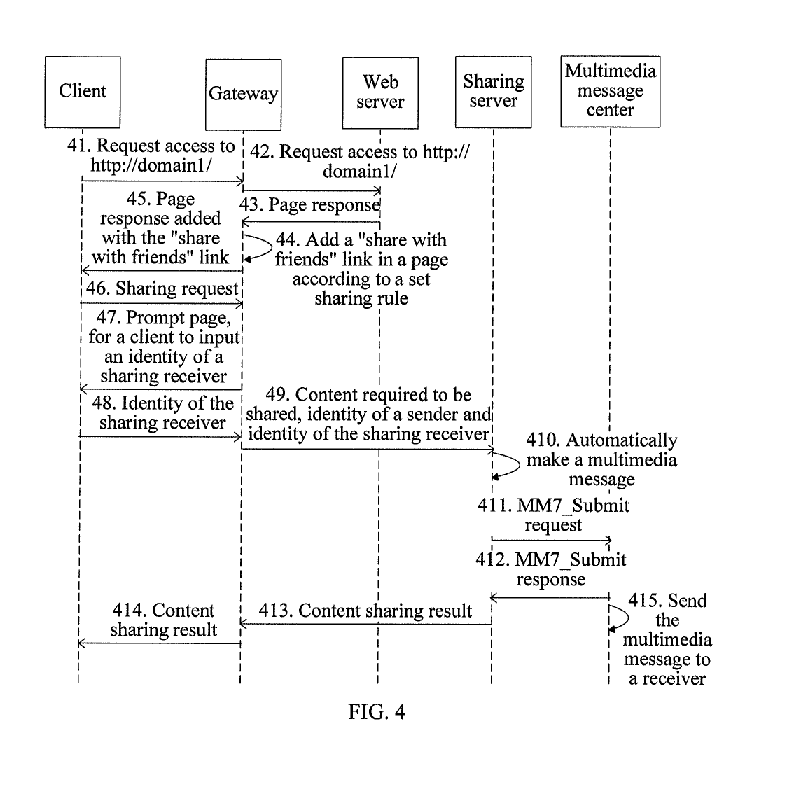

Content required to be shared is sent through a multimedia message. As shown in FIG. 4, the sending method includes the following steps:

Step 41: A gateway receives a service access request from a client, requesting access to http://domain1/.

Step 42: The gateway forwards the request to a Web server.

Step 43: Receive a page response returned by the Web server.

Step 44: The gateway adds a “share with friends” link in the page response according to a set sharing rule.

Step 45: The gateway returns the page response added with the “share with friends” link to the client.

Step 46: The gateway receives a sharing request sent by the client.

If a user needs to share specific content with friends, the user may click the “share with friends” link, and then the gateway may receive the sharing request.

Step 47: The gateway returns a prompt page to enable the client to input an identity of a sharing receiver (for example, a phone number or an Email address).

Step 48: Receive the identity of the sharing receiver submitted by the client.

Step 49: The gateway sends the content required to be shared, the identity of the sender and the identity of the sharing receiver to a sharing server.

Step 410: The sharing server automatically makes a multimedia message of the content required to be shared.

Step 411: The sharing server submits the multimedia message to a multimedia message center by sending an MM7_Submit request.

Step 412: The multimedia message center returns a multimedia message submit response.

Step 413: The sharing server returns a content sharing result to the gateway.

Step 414: The gateway returns the content sharing result to the client.

Step 415: The multimedia message center sends the multimedia message to the sharing receiver according to the identity of the sharing receiver.

In this example, the user can share the content with friends conveniently and instantly when the user browses Internet content, the user is not required to locally download the content required to be shared, and the content provider is also not required to modify the content.

### Example 2

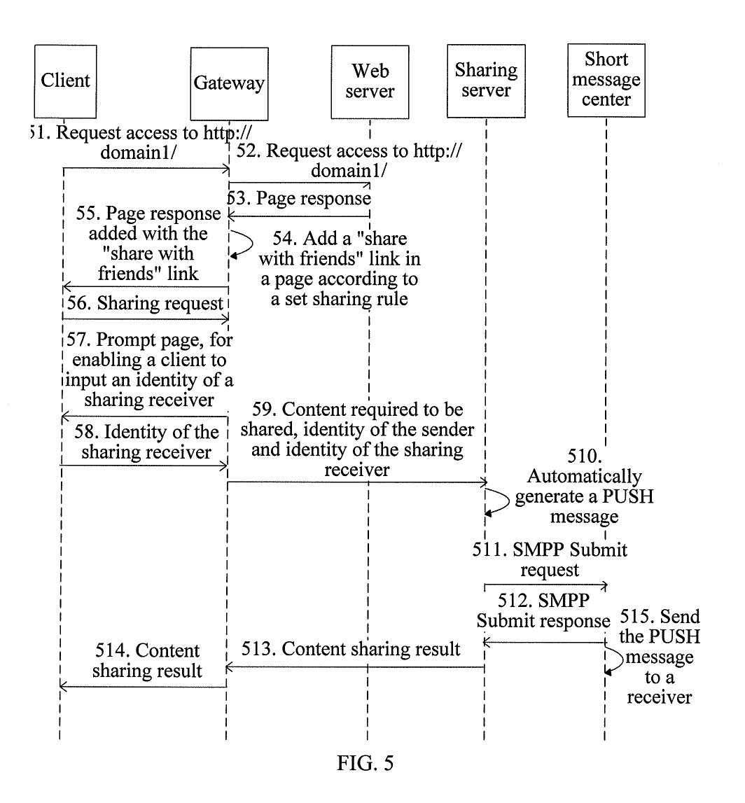

Content required to be shared is sent through a short message. As shown in FIG. 5, the sending method includes the following steps:

Step 51: A gateway receives a service access request from a client, requesting access to http://domain1/.

Step 52: The gateway forwards the request to a Web server.

Step 53: Receive a page response returned by the Web server.

Step 54: The gateway adds a “share with friends” link in the page response according to a set sharing rule.

Step 55: The gateway returns the page response added with the “share with friends” link to the client.

Step 56: The gateway receives a sharing request sent by the client.

If the user needs to share specific content with friends, the user may click the “share with friends” link, and the gateway may receive the sharing request.

Step 57: The gateway returns a prompt page to enable the client to input an identity of a sharing receiver (for example, a phone number or an Email address).

Step 58: Receive the identity of the sharing receiver submitted by the client.

Step 59: The gateway sends the content required to be shared, an identity of a sender and the identity of the sharing receiver to a sharing server.

Step 510: The sharing server automatically makes a PUSH short message of the content to be shared.

Step 511: The sharing server submits the PUSH short message to a short message center through an SMPP Submit request.

Step 512: The short message center returns a short message submit response.

Step 513: The sharing server returns a content sharing result to the gateway.

Step 514: The gateway returns the content sharing result to the client.

Step 515: The short message center sends the PUSH short message to the receiver.

In this example, the user can share the content with friends conveniently and instantly when the user browses Internet content, the user is not required to locally download the content required to be shared, and the content provider is also not required to modify the content.

### Example 3

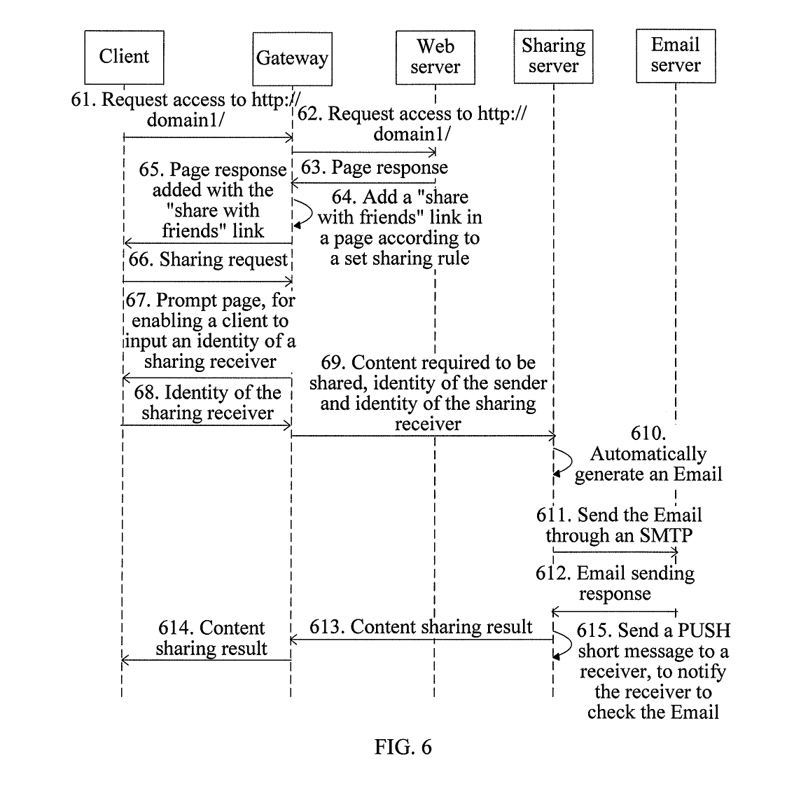

Content required to be shared is sent through an Email. As shown in FIG. 6, the sending method includes the following steps:

Step 61: A gateway receives a service access request from a client to request access to http://domain1/.

Step 62: The gateway forwards the request to a Web server.

Step 63: Receive a page response returned by the Web server.

Step 64: The gateway adds a “share with friends” link in a page according to a set sharing rule.

Step 65: The gateway returns the page response added with the “share with friends” link to the client.

Step 66: The gateway receives a sharing request sent by the client.

If the user needs to share specific content with friends, the user may click the “share with friends” link, and the gateway may receive the sharing request.

Step 67: The gateway returns a prompt page to enable the client to input an identity of a sharing receiver (for example, a phone number or an Email address).

Step 68: Receive the identity of the sharing receiver submitted by the client.

Step 69: The gateway sends the content required to be shared, an identity of a sender and the identity of the sharing receiver to a sharing server.

Step 610: The sharing server automatically makes an Email of the content to be shared.

Step 611: The sharing server sends the Email to an Email server through an SMTP.

Step 612: The Email server returns an Email sending result.

Step 613: The sharing server returns a content sharing result to the gateway.

Step 614: The gateway returns the content sharing result to the client.

Step 615: The sharing server sends a PUSH short message to a receiver, to notify the receiver to check an Email box.

In this example, the user can share the content with friends conveniently and instantly when the user browses Internet content, the user is not required to locally download the content required to be shared, and the content provider is also not required to modify the content.

To sum up, through the embodiments of the present disclosure, the user is not required to locally download the content required to be shared, and the content provider is also not required to modify the content. A network side determines the content to be shared according to the sharing rule, and returns a sharing prompt to the terminal, so that the user can share the content with friends conveniently and instantly when the user browses Internet content. Moreover, the content sharing and propagation are implemented based on the gateway, thereby ensuring the security of a content sharing process.

Persons skilled in the art should understand that all or a part of the steps of the method according to the embodiments of the present disclosure may be implemented by a program instructing relevant hardware such as a processor. The program may be stored in a computer readable storage medium, such as a Read-Only Memory (ROM for short), a Read-Access Memory (RAM for short), a magnetic disk or an optical disk accessible by the processor.

The above descriptions are merely exemplary embodiments of the present disclosure, but the protection scope of the present disclosure is not limited hereto. Any modification, equivalent replacement, or improvement made by persons skilled in the art without departing from the technical scope of the present disclosure should fall within the protection scope of the present disclosure. Therefore, the protection scope of the present disclosure is subject to the protection scope of the claims.

What is claimed is:

1. A method for content sharing and propagation, comprising:
receiving, by a gateway, a service access request sent by a terminal, and obtaining content corresponding to the service access request from a network server;
determining content required to be shared in the content corresponding to the service access request according to a sharing rule and feeding back a sharing prompt to the terminal;
receiving a sharing request sent by the terminal; and
sending the content required to be shared according to the sharing request.

2. The method according to claim 1, further comprising:
authenticating, by the gateway, the terminal.

3. The method according to claim 1, wherein sharing rule comprises at least one of the following:
combining conditions of a terminal identity, a terminal type and a website address as the sharing rule;
a word count of a text paragraph in a web page exceeding a certain amount;
a label of a subject included in a markup language; and
a sharing rule for a picture in the web page, wherein the sharing rule comprises any one or any combination of a width limit, a height limit, a size limit and a picture type of the picture.

4. The method according to claim 1, wherein feeding back the sharing prompt to the terminal comprises:
adding a sharing link in a web page comprising the content required to be shared, and sending the web page added with the sharing link to the terminal.

5. The method according to claim 1, wherein sharing request comprises an identity of a sharing receiver.

6. The method according to claim 5, wherein sending the content required to be shared according to the sharing request comprises:
providing, by the gateway, an identity of the terminal, the identity of the sharing receiver, and the content required to be shared to a sharing server, and sending, by the sharing server, the content required to be shared to the sharing receiver according to the identity of the sharing receiver.

7. The method according to claim 6, wherein sharing server sends the content required to be shared through a multimedia message center, a short message center or an Email server.

8. A gateway, comprising:
a first receiving unit, configured to receive a service access request sent by a terminal, and obtain content corresponding to the service access request from a network server;
a shared content determination and feedback unit, configured to determine content required to be shared in the content corresponding to the service access request according to a sharing rule and feed back a sharing prompt to the terminal;
a second receiving unit, configured to receive a sharing request sent by the terminal; and
a sending unit, configured to send the content required to be shared according to the sharing request.

9. The gateway according to claim 8, wherein the shared content determination and feedback unit further comprises:
a determination sub-unit, configured to determine content required to be shared in the content corresponding to the service access request according to the sharing rule; and
a feedback sub-unit, configured to add a sharing link in a page comprising the content required to be shared, and sending the page added with the sharing link to the terminal.

10. The gateway according to claim 8, further comprising:
an authentication unit, configured to authenticate the terminal.

11. A system for content sharing and propagation, comprising: a network server and a gateway, wherein
the network server is configured to provide a page of content corresponding to a service access request to the gateway after receiving a service access request forwarded by the gateway; and
the gateway is configured to receive the service access request sent by a terminal, obtain content corresponding to the service access request from the network server, determine content required to be shared in the content corresponding to the service access request according to a sharing rule, feed back a sharing prompt to the terminal, and send the content required to be shared according to a sharing request after receiving the sharing request sent by the terminal.

12. The system according to claim 11, further comprising: a sharing server, wherein the sharing server is connected to the gateway, and is configured to send the content required to be shared to a sharing receiver.

13. The system according to claim 12, wherein the sharing server is connected to a multimedia message center, a short message center or an Email server, and the sharing server is configured to send, through a multimedia message, a short message, or an Email, the content required to be shared.
